(19) United States
(12) Patent Application Publication
(10) Pub. No.: US 2026/0067468 A1
(43) Pub. Date: Mar. 5, 2026

(54) CROSS-COMPONENT PREDICTION IN MULTI-PARTITION PREDICTION MODE

(71) Applicant: Tencent America LLC, Palo Alto, CA (US)

(72) Inventors: Lien-Fei CHEN, Palo Alto, CA (US); Roman CHERNYAK, Palo Alto, CA (US); Ziyue XIANG, Palo Alto, CA (US); Biao WANG, Palo Alto, CA (US); Stephan WENGER, Palo Alto, CA (US); Yifan WANG, Palo Alto, CA (US); Yonguk YOON, Palo Alto, CA (US); Shan LIU, Palo Alto, CA (US)

(21) Appl. No.: 19/313,726

(22) Filed: Aug. 28, 2025

Related U.S. Application Data
(60) Provisional application No. 63/690,239, filed on Sep. 3, 2024.
(60) Provisional application No. 63/713,553, filed on Oct. 29, 2024.
(60) Provisional application No. 63/720,087, filed on Nov. 13, 2024.

(51) Int. Cl. H04N 19/14; H04N 19/176; H04N 19/186

(52) U.S. Cl. CPC H04N 19/14; H04N 19/176; H04N 19/186

(57) ABSTRACT

The various implementations described herein include methods and systems for coding video. In one aspect, a video bitstream includes a current coding block of a current image frame and a first syntax element for a multi-partition prediction mode. Based on the first syntax element, the computing system determines that the multi-partition prediction mode is enabled to reconstruct the current coding block based on a plurality of partitions. Each of the plurality of partitions corresponds to a set of respective model parameters that is applied to reconstruct a respective chroma sample based on a set of respective luma samples. The computing system determines that a first chroma sample is located in a first partition, combines a set of first luma samples using a set of first model parameters to generate the first chroma sample, and reconstructs the current image frame including the first chroma sample of the current coding block.

### RELATED APPLICATION

This application claims priority to U.S. Provisional Patent Application No. 63/690,239, entitled “Cross-Component Prediction in Multi-Partition Prediction Mode,” filed Sep. 3, 2024; U.S. Provisional Patent Application No. 63/720,087, entitled “Implicit GPM Partition Derivation,” filed Nov. 13, 2024; and U.S. Provisional Patent Application No. 63/713,553, entitled “Geometric Partition Mode for AMVP-Merge Prediction Mode,” filed Oct. 29, 2024. Each of the above provisional applications is hereby incorporated by reference in its entirety.

### TECHNICAL FIELD

The disclosed embodiments relate generally to video coding, including but not limited to systems and methods for processing video data.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

As mentioned above, encoding (compression) reduces the bandwidth and/or storage space requirements. As described in detail later, both lossless compression and lossy compression can be employed. Lossless compression refers to techniques where an exact copy of the original signal can be reconstructed from the compressed original signal via a decoding process. Lossy compression refers to coding/decoding process where original video information is not fully retained during coding and not fully recoverable during decoding. When using lossy compression, the reconstructed signal may not be identical to the original signal, but the distortion between original and reconstructed signals is made small enough to render the reconstructed signal useful for the intended application. The amount of tolerable distortion depends on the application. For example, users of certain consumer video streaming applications may tolerate higher distortion than users of cinematic or television broadcasting applications. The compression ratio achievable by a particular coding algorithm can be selected or adjusted to reflect various distortion tolerance: higher tolerable distortion generally allows for coding algorithms that yield higher losses and higher compression ratios.

The present disclosure describes cross component intra or inter prediction of video data in a cross component prediction (CCP) mode where each of a plurality of samples of a second color component of a current coding block is determined based on one or more associated samples of a first color component of a reference coding block (e.g., the current coding block itself). The CCP mode corresponds to a multi-tap model that includes a number (N) of taps. Each tap is selected from a sample of the first color component and the one or more associated neighboring samples of the first color component. In some embodiments, each of a subset of taps may correspond to a nonlinear term or an offset term. The selected taps are combined using a plurality of model parameters to determine the sample of the second color component. In some embodiments, the sample of the first color component is a luma sample, and the sample of the second color component is a chroma sample. The chroma sample is a weighted combination of terms selected from a respective luma sample, one or more neighboring luma sample, a nonlinear term, and the offset term. In some embodiments, when the CCP mode is enabled for a current coding block, samples of a respective reference area are applied to determine the model parameters.

In some embodiments, when samples of a first color components are applied to determine samples of a second color component, each sample of the first color component is a luma sample, and each sample of the second color component is a blue-difference chroma (Cb) sample or a red-difference chroma (Cr) component. Alternatively, in some embodiments, the first color component is one of the red, green, and blue colors, and the second color component is another one of the red, green, and blue colors. Alternatively, in some embodiments, the first color component and the second component correspond to a color format that is distinct from a YCbCr color format and an RGB color format.

In accordance with some embodiments, a method of video decoding is provided. The method includes receiving a video bitstream including a current coding block of a current image frame, wherein the video bitstream includes a first syntax element for a multi-partition prediction mode (also called a multiple prediction block mode); based on the first syntax element, determining that the multi-partition prediction mode is enabled to reconstruct the current coding block based on a plurality of partitions; determining that each of the plurality of partitions includes a respective chroma sample and corresponds to a set of respective model parameters applied to reconstruct the respective chroma sample based on a set of respective luma samples; determining that a first chroma sample is located in a first partition corresponding to a set of first model parameters; combining a set of first luma samples using the set of first model parameters to generate the first chroma sample of the current coding block; and reconstructing the current image frame including the first chroma sample of the current coding block.

In accordance with some embodiments, a method of video encoding is provided. The method includes receiving video data comprising a current coding block of a current image frame, encoding the current image frame, transmitting the encoded current image frame via a video bitstream, and signaling, via the video bitstream, a first syntax element 502 for a multi-partition prediction mode. When the multi-partition prediction mode is enabled, the current coding block is reconstructed based on a plurality of partitions, and each of the plurality of partitions include a respective chroma sample and a set of respective luma samples, and corresponds to a set of respective model parameters applied to reconstruct the respective chroma sample based on the set of respective luma samples.

In accordance with some embodiments, a method of bitstream conversion is provided. The method includes obtaining a source video sequence including a current image frame and performing a conversion between the source video sequence and a video bitstream. The video bitstream comprises the current image frame that further includes a current coding block and a first syntax element for a multi-partition prediction mode. When the multi-partition prediction mode is enabled, the current coding block is reconstructed based on a plurality of partitions, and each of the plurality of partitions include a respective chroma sample and a set of respective luma samples, and corresponds to a set of respective model parameters applied to reconstruct the respective chroma sample based on the set of respective luma samples.

In accordance with some embodiments, another method of video decoding is provided. The method includes receiving a video bitstream including a current image frame including a current coding block, wherein the video bitstream includes a first syntax element for a geometric partitioning mode (GPM) and a second syntax element for an advanced motion vector prediction (AMVP) merge prediction mode; based on the first syntax element and the second syntax element, determining that the GPM is enabled to apply non-rectangular partitioning to the current coding block and that the AMVP-merge prediction mode is enabled to apply AMVP on at least one of a plurality of partitions of the current coding block; extracting, from the video bitstream, a first motion vector prediction (MVP) and a first motion vector difference (MVD) for a first partition of the plurality of partitions of the current coding block; determining an AMVP prediction block for the first partition of the current coding block based on the first MVP and the first MVD; and reconstructing the current image frame including the current coding block based on the AMVP prediction block of the first partition.

In accordance with some embodiments, another method of video decoding is provided. The method includes receiving a video bitstream including a current image frame including a current coding block, wherein the video bitstream includes a first syntax element for a geometric partition mode (GPM); based on the first syntax element, determining that the GPM is enabled to apply a non-rectangular partition of the current coding block; identifying a reference area of the current coding block including a top reference region, the top reference region including one or more rows of reference samples located above a first row of the current coding block; determining a respective gradient value for each sample of the top reference region; identifying a partition location in the top reference region based on respective gradient values of a plurality of samples of the top reference region; determining a partition line of the current coding block based on the partition location in the top reference region; and reconstructing the current image frame including the current coding block based on the partition line of the current coding block.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating a communication system in accordance with some embodiments.

FIG. 2A is a block diagram illustrating example elements of the encoder component in accordance with some embodiments.

FIG. 2B is a block diagram illustrating example elements of the decoder component in accordance with some embodiments.

FIG. 3 is a block diagram illustrating the server system in accordance with some embodiments.

FIG. 4 illustrates an example scheme for generating a first chroma sample from one or more luma samples in a CCP mode (e.g., a multi-hypothesis CCP (MHCCP) mode), in accordance with some embodiments.

FIG. 5 illustrates an example current image frame having a plurality of partitions of a current coding block that are coded with respective model parameters, in accordance with some embodiments.

FIG. 6 is a flow diagram of an image decoding process of determining CCP model parameters based on prediction samples, in accordance with some embodiments.

FIG. 7 is a flow diagram of another image decoding process of determining CCP model parameters based on samples of a reference area, in accordance with some embodiments.

FIG. 8 is a flow diagram illustrating an example method 800 of decoding video, in accordance with some embodiments.

FIG. 9A illustrates an example current coding block coded with an AMVP-merge prediction mode, in accordance with some embodiments.

FIG. 9B illustrates another example current coding block having a reference area and coded with an AMVP-merge prediction mode, in accordance with some embodiments.

FIG. 10 is a flow diagram illustrating an example method of decoding video, in accordance with some embodiments.

FIGS. 11A and 11B are diagrams illustrating an example method of determining a geometric split edge that splits a current coding block to two partitions in a geometric partition mode (GPM), in accordance with some embodiments.

FIG. 12 is a diagram illustrating an example method of determining a plurality of geometric split edges that split a current coding block to more than two partitions in a GPM, in accordance with some embodiments.

FIG. 13 is a flow diagram illustrating an example method of decoding video, in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video compression methods using intra prediction and inter prediction. Samples of a current coding block may be reconstructed from samples of a reference coding block based on a model having a plurality of model parameters. For example, the model is used to predict a chroma sample of the current coding block as a linear or nonlinear weighted sum of multiple inputs of luma samples of the reference coding block, which may be the same as the current coding block. In some embodiments, the model parameters are derived based on a correlation between inter prediction luma samples and inter prediction chroma samples, and applied on a luma reconstructed block to predict a chroma reconstructed block. In some embodiments, a current coding block is coded with a GPM, and a plurality of prediction blocks are predicted from one or more reference picture(s) and fused with a derived blending mask to generate a final prediction block. For example, two prediction blocks are fused in the GPM mode. Alternatively, in some embodiments, for a HEVC prediction unit, a plurality of prediction blocks may correspond to the same coding block.

In some embodiments, a reference area associated with the current coding block and/or an associated reference coding block includes a plurality of reconstructed neighboring samples (e.g., luma and chroma samples), which are used to determine the plurality of model parameters of the model used to reconstruct the samples of the current coding block. For example, the model parameters may be determined by feeding neighboring reconstructed samples (e.g., in the reference area) of the current coding block and the reference coding block into a least mean square calculation kernel.

Some implementation application is directed to an advanced motion vector prediction AMVP-merge prediction mode, in which a bi-directional predictor includes an AMVP predictor in a first direction and a merge predictor in a second direction. The AMVP predictor is signalled as a unidirectional AMVP (e.g., including a reference index and a motion vector difference (MVD), and has a derived motion vector prediction (MVP) index if template matching is used or an MVP index is signalled when template matching is disabled. For a AMVP direction Lx, where x can be 0 or 1, while the merge predictor (1-Lx) is implicitly derived. When the AMVP-merge prediction mode is based on bilateral-matching, a bilateral matching cost may be calculated using a merge candidate motion vector (MV) and a AMVP MV for every merge candidate in a merge candidate list, which has a distinct motion vector at a direction 1-Lx. The merge candidate with the smallest cost is selected. A bilateral matching refinement is applied to the coding block with the selected merge candidate MV and the AMVP MV as a starting point.

Some implementations of this application are directed to implicit GPM partition derivation based on a gradient of a reference line (e.g., a reference row, a reference column) of a current coding block. The gradient of the reference row or column is applied to determine a peak sample having a largest sample value on the reference row or column and an associated position of the sample. A peak sample on the reference row and a peak sample on the reference column are connected to divide the current coding block into at least two partitions of the current coding block. When two or more separate peak samples are identified on the reference row and/or column, the current coding block may be divided into more than two partitions using lines connecting the peak samples on the reference column and row of the current coding block.

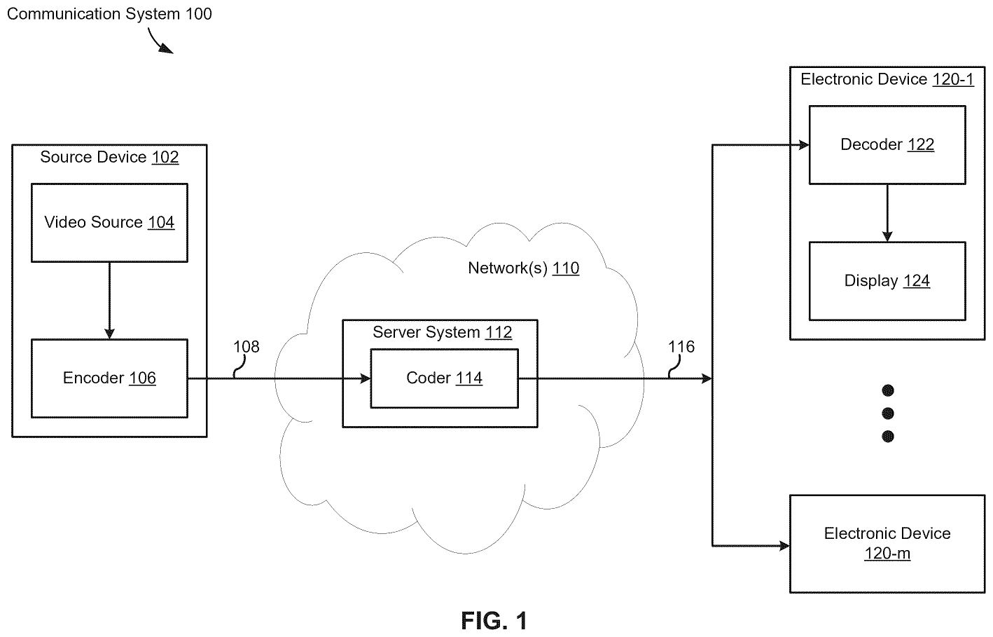

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

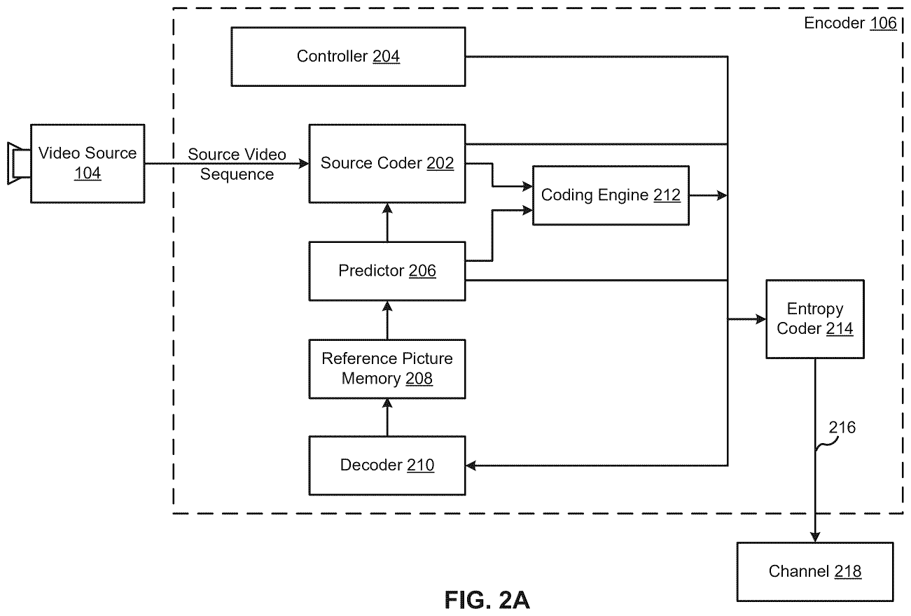

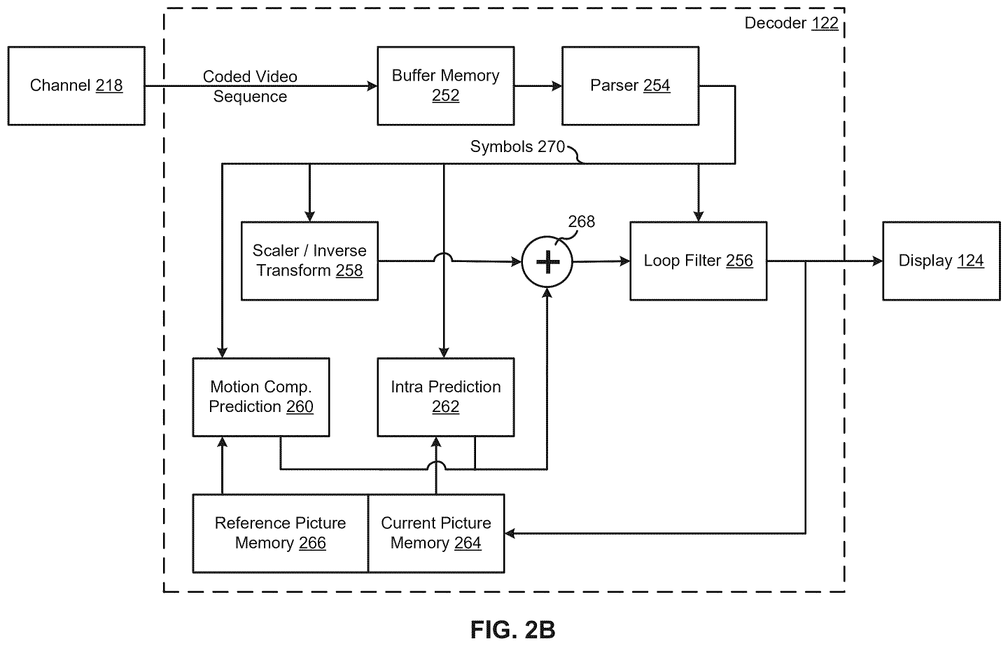

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding. This principle of reference picture synchronicity (and resulting drift, if synchronicity cannot be maintained, for example because of channel errors) is known to a person of ordinary skill in the art.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. The description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, for example, temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation also can include interpolation of sample values as fetched from the reference picture memory 266 when sub-sample exact motion vectors are in use, motion vector prediction mechanisms, and so forth.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

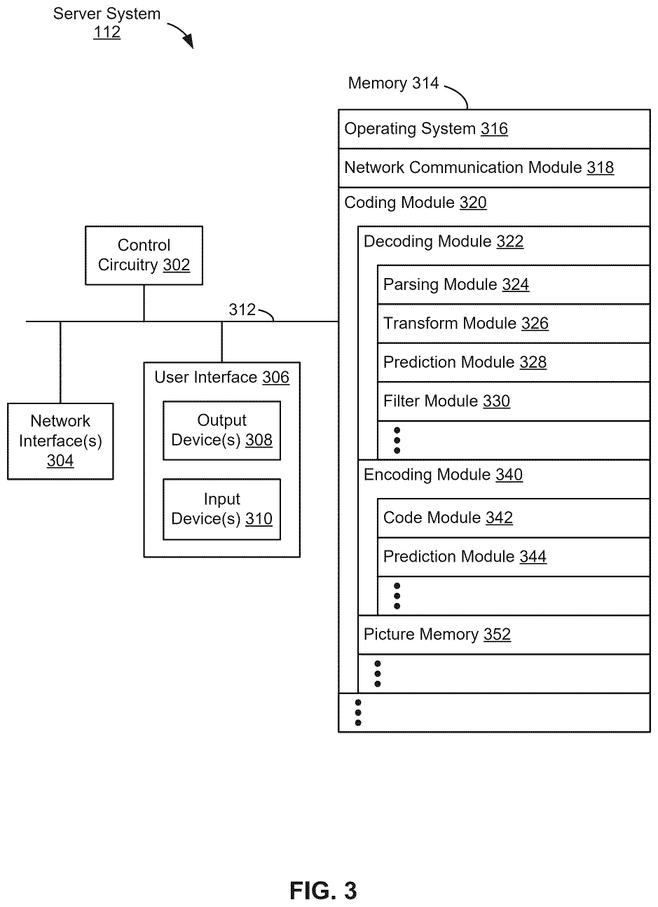

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes one or more field-programmable gate arrays (FPGAs), hardware accelerators, and/or one or more integrated circuits (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above, such as an audio processing module.

Although FIG. 3 illustrates the server system 112 in accordance with some embodiments, FIG. 3 is intended more as a functional description of the various features that may be present in one or more server systems rather than a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

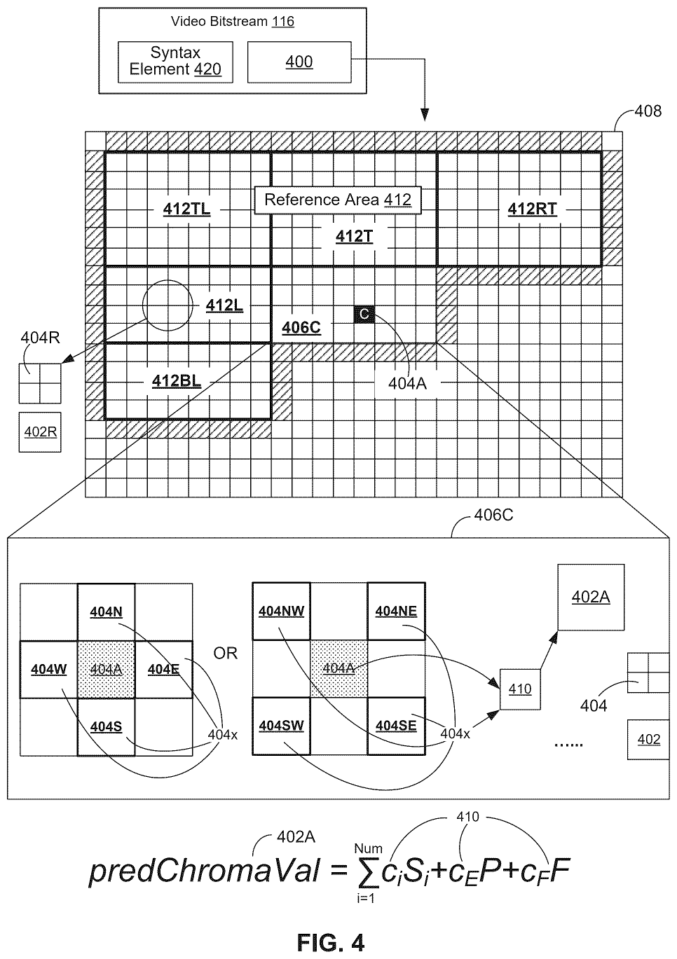

FIG. 4 illustrates an example scheme 400 for generating a first chroma sample 402A from one or more luma samples 404 (e.g., 404A and 404X) in a CCP mode (e.g., a multi-hypothesis CCP (MHCCP) mode), in accordance with some embodiments. In some embodiments, a video bitstream 116 includes a current coding block 406C of the current image frame 408 and a syntax element 420 for the CCP mode. The syntax element 420 indicates whether to reconstruct the first chroma sample 402A of the current coding block 406C based on a set of one or more luma samples 404 of a reference coding block based on a plurality of model parameters 410. Referring to FIG. 4, in an example, the reference coding block is the current coding block 406C itself. In some embodiments, the syntax element 420 is signaled in the video bitstream 116 at one of a block level, a superblock level, an image frame level, a slice level, a tile level, and an image sequence level for the current coding block 406C.

In some embodiments (FIG. 4), the CCP mode includes a cross-component intra prediction (CCIP) mode, and a current coding block 406C of a current image frame 408 is coded in the CCIP mode. In the CCIP mode, the current coding block 406C includes a chroma block, and corresponds to a reference coding block including a co-located luma block. A decoder 122 (FIG. 2B) determines each of a plurality of chroma samples 402 of the current coding block 406C based on one or more luma samples 404 of the reference coding block that have been reconstructed. In some situations, the CCIP mode includes a cross-component linear model (CCLM) mode in which a first chroma sample 402A is converted from a reconstructed luma sample 404A that is co-located with the chroma sample 402A based on a linear model. Alternatively, in some situations, the CCIP mode includes a convolutional cross-component mode (CCCM) in which a first chroma sample 402A is predicted directly from a plurality of reconstructed luma samples 404X that is located adjacent to the first luma sample 404A based on a filter shape of a filter. Alternatively and additionally, in some situations, the CCIP mode includes the MHCCP mode in which a first chroma sample 402A is generated by combining at least the first luma sample 404A that is collocated with the first chroma sample 402A and a plurality of hypothesis values using a plurality of weighing factors. The plurality of neighboring luma samples 404X of the first luma sample 404A are combined using a plurality of coefficients to generate the plurality of hypothesis values. Stated another way, in the MHCCP mode, the first luma sample 404A and the plurality of neighboring luma samples 404X are combined using a plurality of model parameters 410 (which are associated with the weighing factors and the coefficients) to generate the first chroma sample 402A. The first chroma sample 402A is a blue-difference chroma (Cb) sample or a red-difference chroma (Cr) component.

In some embodiments, a video bitstream 116 includes a syntax element 420 for an MHCCP mode. The first chroma sample 402A of the current coding block 406C is configured to be generated by combining at least the first luma sample 404A that is co-located with the first chroma sample 402A and one or more neighboring luma samples 404X of the first luma sample 404A using a plurality of model parameters (e.g., cᵢ, c_{E}, c_{F}). In accordance with a determination that the MHCCP mode is applied, the first chroma sample 402A is predicted according to the following model:

$$predChromaVal = {\sum }_{i = 0}^{Num} {c}_{i} \cdot {S}_{i} + {c}_{E} \cdot E + {c}_{F} \cdot F \qquad ( 1 )$$

where predChromaVal is a predicted chroma value of the first chroma sample 402A; Num is a total number of neighboring luma samples 404X; Si is a luma value of the first luma sample 404A (where i is equal to 0) or a neighboring luma sample 404X (where i is greater than 0), which is indexed by i; E is a nonlinear term; F is an offset term; and cᵢ, c_{E}, c_{F} are model parameters. In an example, the nonlinear term E is equal to equal to (C×C+F)>>bit_depth, where C is a sample value of the first luma sample 404A, and bit_depth is the number of bits needed to represent luma samples of the current image frame 408 during encoding and decoding. In some embodiments, F is a median luma value, a middle luma value, or an average luma value of the luma samples 404 of the current coding block 406C. In another example, F is equal to 1<<(bit_depth−1). In the MHCCP mode, the chroma samples 402 of the current coding block 406C do not need to be transmitted in the video bitstream 116, thereby conserving a communication bandwidth of a video codec.

In some embodiments, each of the one or more neighboring luma samples 404X of the first luma sample 404A is immediately adjacent to, and shares at least one respective side or vertex with, the first luma sample 404A. In some embodiments, the one or more neighboring luma samples 404X include a subset or all of a north neighboring luma sample (also called a top luma sample) 404N, a south neighboring luma sample (also called a bottom luma sample) 404S, a west neighboring luma sample (also called a left luma sample) 404W, an cast neighboring luma sample (also called a right luma sample) 404E, a northwest neighboring luma sample (also called a top left luma sample) 404NW, a southeast neighboring luma sample (also called a bottom right luma sample) 404SE, a southwest neighboring luma sample (also called a bottom left luma sample) 404SW, and a northeast neighboring luma sample (also called a top right luma sample) 404NE.

In some embodiments, equation (1) includes five terms, and represents a five tap model for determining the first chroma sample 402A of the current coding block 406C based on three linear terms (e.g., associated with the first luma sample 404A and neighboring luma samples 404W and 404E), the nonlinear term E, and the offset term F in the MHCCP mode. Alternatively, in some embodiments, equation (1) includes seven terms, and represents a seven tap model for determining the first chroma sample 402A of the current coding block 406C based on three linear terms (e.g., associated with luma samples 404A, 404W, 404E, 404N, and 404S), the nonlinear term E, and the offset term F in the MHCCP mode.

In some embodiments, the plurality of model parameters cᵢ, c_{E}, and cp are determined based on a set of one or more reference luma samples 404R and a set of one or more co-located reference chroma samples 402R within a reference area 412 of the current coding block 406C. The reference area 412 is located in the current image frame 408. Further, in some embodiments, the reference luma samples 404R of the reference area 412 are combined to re-generate one or more chroma samples 402A based on equation (1). In some embodiments, the set of one or more co-located reference chroma samples 402R and the one or more re-generated chroma samples are compared to generate a least mean square (LMS) value. The plurality of model parameters cᵢ, c_{E}, c_{F} are iteratively adjusted to reduce the LMS value, until the LMS value satisfies a predefined criterion (e.g., in which the LMS value is below a threshold LMS value or is minimized).

In some embodiments, the plurality of model parameters cᵢ, c_{E}, c_{F} are at least partially derived based on chroma samples and luma samples within the reference area 412 of the current coding block 406C, and the reference area 412 includes one or more coding blocks (e.g., 4 coding blocks in FIG. 4) that are decoded prior to, the current coding block 406C. In some embodiments, a subset of the one or more coding blocks is immediately adjacent to the current coding block 406C. In some embodiments, a subset of the one or more coding blocks are separated from the current coding block 406C by one or more coding blocks. In some embodiments, the reference area 412 includes at least a portion of one or more rows above the current coding block 406C and/or a portion of one or more columns to the left of the current coding block 406C. For example, referring to FIG. 4, the reference area 412 includes seven rows of luma samples 404R above the current coding block 406C and nine columns of luma reference samples 404R to the left of the current coding block 406C. The reference area 412 may include a padded row and a padded column (e.g., shaded in FIG. 4).

Additionally, in some embodiments, the reference area 412 of the current coding block 406C includes one or more of: a top left reference region 412TL, a top reference region 412T, a top right reference region 412TR, a bottom left reference region 412BL, and a left reference region 412L. In an example, the reference area 412 includes the top reference region 412T and the left reference region 412L. Each of the reference regions includes one or more coding blocks. Stated another way, in some embodiments, the reference area 412 includes at least a portion of a plurality of rows above the current coding block 406C and/or a portion of a plurality of columns to the left of the current coding block 406. For example, referring to FIG. 4, the reference area 412 includes a first portion of 6 rows of chroma samples above the current coding block 406C and a second portion of 8 columns of chroma samples to the left of the current coding block 406C. A column number of the first portion is determined by a column number of the current coding block 406C, and a row number of the second portion is determined by a row number of the current coding block 406C. In some embodiments, the reference area 412 extends one coding block width to the right of a right boundary of the current coding block 406, and one coding block height below a bottom boundary of the current coding block 406. In some embodiments, the reference area 412 is adjusted to include only available samples. Extensions 412E to the reference area 412 are padded in unavailable areas to provide side samples of a filter.

In some embodiments, the reconstructed luma samples 404R and chroma samples 402R of the reference area 412 are used to generate the model parameters in the CCP mode. The reference area 412 may be L-shaped, including bottom left, left, top left, above and above right reference regions. For example, the reference area 412 has a first integer number K (e.g., 6) of reference lines above the current coding block 406C and a second integer number L (e.g., 8) columns to the left of the current coding block 406C. Extensions 412E to the reference area 412 include padded pixels for the reference samples.

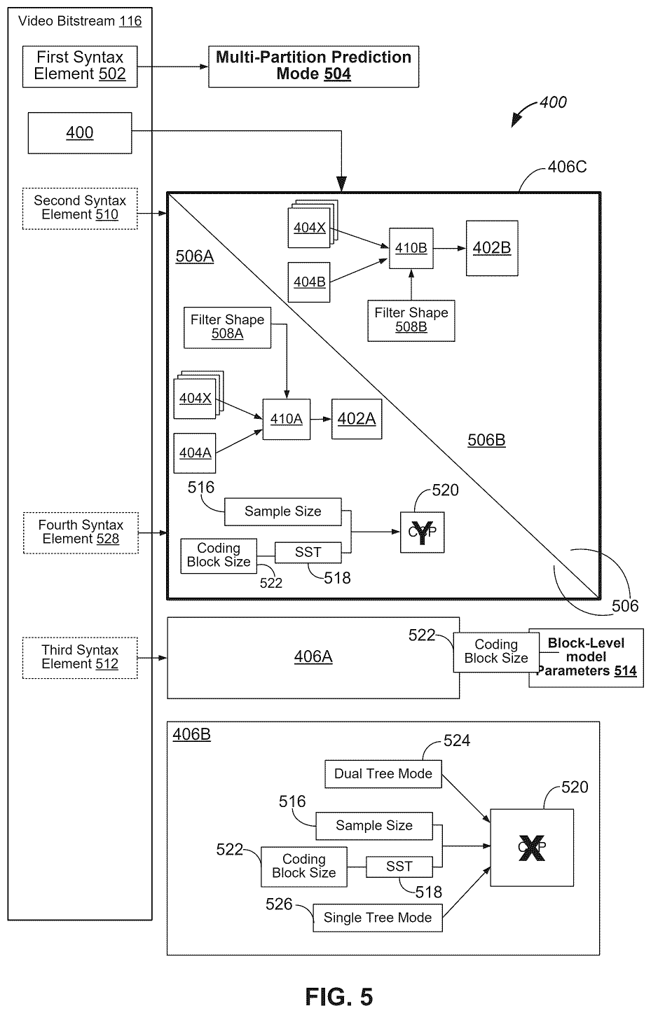

FIG. 5 illustrates an example current image frame 400 having a plurality of partitions 506 of a current coding block 406C that are coded with respective model parameters 410, in accordance with some embodiments. An encoder 106 of a source device 102 (FIG. 1) obtains a source video sequence including a current image frame 400 and performs a conversion between the source video sequence and a video bitstream 108. The video bitstream 108 includes the current image frame 400 that further includes the current coding block 406C and a first syntax element 502 for a multi-partition prediction mode 504 (also called a multiple prediction block mode). In some embodiments, the video bitstream 108 is forwarded as a video bitstream 116 by a server system 112. A decoder 122 of an electronic device 102-1 (FIG. 1) receives the video bitstream 116 including the current coding block 406C of the current image frame 400, and the video bitstream 116 includes the first syntax element 502 for the multi-partition prediction mode 504.

Based on the first syntax element 502, the decoder 122 determines that the multi-partition prediction mode 504 is enabled to reconstruct the current coding block 406C based on a plurality of partitions 506 (e.g., a first partition 506A, a second partition 506B). Each of the plurality of partitions 506 includes a respective chroma sample 402 and corresponds to a set of respective model parameters 410 applied to reconstruct the respective chroma sample 402 based on a set of respective luma samples 404. A first chroma sample 402A is located in a first partition 506A corresponding to a set of first model parameters 410A, and a set of first luma samples 404-1 are combined using the set of first model parameters 410A to generate the first chroma sample 402A of the current coding block 406C. The decoder 122 reconstructs the current image frame 400 including the first chroma sample 402A of the current coding block 406C.

In some embodiments, the set of first luma samples 404-1 includes a first luma sample 404A that is co-located with the first chroma sample 402A and one or more neighboring luma samples 404X. In an example, equation (1) is applied to generate the first chroma sample 402A based on the set of first luma samples 404-1.

In some embodiments, a second chroma sample 402B is located in a second partition 506B corresponding to a set of second model parameters 410B. A set of second luma samples 404-2 are combined using the set of second model parameters 410B to generate the second chroma sample 402B of the current coding block 406C. The current image frame 400 is reconstructed based on both the first chroma sample 402A and the second chroma sample 402B of the current coding block 406C. The set of first model parameters 410A is distinct from the set of second mode parameters 410B. Further, in some embodiments, the set of first model parameters 410A of the first partition 506A corresponds to a first filter shape 508A, and the set of second model parameters 410B of the second partition 506 corresponds to a second filter shape 508B distinct from the first filter shape 508A. For example, the first filter shape 508A includes luma samples 404A, 404W, and 404E, and the second filter shape 508B includes luma samples 404A, 404N, and 404S.

In some embodiments, both the set of first model parameters 410A of the first partition 506A and the set of second model parameters of the second partition correspond to a first filter shape (e.g., a cross shape involving samples 404N, 404W, 404E, and 404S in FIG. 4), and at least one of the set of first model parameters 410A is different from a respective one of the set of second model parameters 410B. For example, a model parameter 410A corresponding to a linear term of the luma sample 404N is different for the first partition 506A and the second partition 506B.

In some embodiments, the multi-partition prediction mode 504 indicated by the first syntax element 502 includes a geometric partitioning mode (GPM), and the first syntax element 502 indicates that the GPM is enabled to apply non-rectangular partitioning to the current coding block 406C and create the plurality of partitions 506. For example, the first partition 506A has a triangle or a trapezoid shape.

In some embodiments, at least two different sets of model parameters 410A and 410B are applied to the plurality of partitions 506 of the current coding block 406C, independently of a plurality of syntax elements included in the video bitstream 116. Stated another way, the model parameters 410 are determined independently for each partition 506 by default, and no signaling is needed to define whether the model parameters 410 are the same or different for the plurality of partitions 506. Conversely, in some embodiments, signaling is needed. The video bitstream 116 includes a second syntax element 510 for a partition-based cross-component prediction (CCP) mode. The second syntax element 510 indicates that the partition-based CCP mode is enabled to apply two or more sets of model parameters to the plurality of partitions of the current coding block 406C.

In some embodiments, the video bitstream 116 includes a third syntax element 512 for a partition-based CCP mode. The decoder 122 determines that the third syntax element 512 indicates that the partition-based CCP mode is disabled for a first coding block 406A, and applies a set of block-level model parameters 514 to a plurality of partitions of the first coding block 406A.

In some embodiments, the current image frame 400 further includes a second coding block 406B distinct form the current coding block 406C. In accordance with a determination that the multi-partition prediction mode 504 is enabled for luma samples of the second coding block 406B and that a dual-tree mode 524 is enabled, cross component prediction (CCP) 520 is disabled for reconstructing chroma samples of the second coding block 406B.

In some embodiments, the current image frame 400 further includes a second coding block 406B distinct form the current coding block 406C. In accordance with a determination that the multi-partition prediction mode 504 is enabled for luma samples of the second coding block 404B, that a dual-tree mode 524 is enabled, and that a sample size 516 (e.g., a bit depth) of the luma samples of the second coding block 404B is greater than or equal to a sample size threshold (SST) 518, cross component prediction 520 is disabled for reconstructing chroma samples of the second coding block 406B. Further, in some embodiments, the decoder 122 determines a coding block size 522 of the second coding block 406B, and the sample size threshold 518 based on the coding block size 522 of the second coding block 406B.

In some embodiments, for the first partition 506A of the current coding block 406C, in accordance with a determination that a sample size 516 (e.g., a bit depth) of luma samples of the first partition 506A is equal to or lower than a sample size threshold 518, the decoder determines that the video bitstream 116 includes a fourth syntax element 528 for a CCP mode 520, the fourth syntax element 528 indicating that the CCP mode 520 is enabled to reconstruct the first chroma sample 402A of the first partition 506A based on the set of first luma samples 404A. Further, in some embodiments, the decoder 122 determines a coding block size 522 of the current coding block 406C, and the sample size threshold 518 based on the coding block size 522 of the current coding block 406C.

In some embodiments, in accordance with a determination that a sample size 516 (e.g., a bit depth) of luma samples 404 of at least one of the plurality of partitions 506 is equal to or lower than a sample size threshold 518, determining that the video bitstream includes a second syntax element 510 for a partition-based CCP mode, the second syntax element 510 indicates that the partition-based CCP mode is enabled to apply two or more sets of model parameters 410 to the plurality of partitions 506 of the current coding block 406C. Further, in some embodiments, the decoder 122 determines a coding block size 522 of the current coding block 406C, and the sample size threshold 518 based on the coding block size 522 of the current coding block 406C.

In some embodiments, the current image frame 400 further includes a second coding block 406B distinct form the current coding block 406C, in accordance with a determination that the multi-partition prediction mode 504 is enabled for luma samples of the second coding block 406B and that a single-tree mode 526 is enabled for chroma samples of the second coding block 406B, cross component prediction 520 is disabled for reconstructing chroma samples of the second coding block 406B.

In some embodiments, the multi-partition prediction mode 504 corresponds to a GPM, where non-rectangular partitioning is applied to the current coding block 406C. In accordance with a determination that the GPM is enabled for the current coding block 406C, the decoder 122 determines that the current coding block 406C is reconstructed based on the plurality of partitions 506. In some embodiments, the decoder 122 determines that the current coding block 406C is coded in one of an inter prediction mode, an intra block copying mode, and an intra template-matching based prediction mode.

In some embodiments, the decoder 122 determines that the current coding block 406C is coded in one of an inter prediction mode, an intra block copying mode, and an intra template-matching based prediction mode.

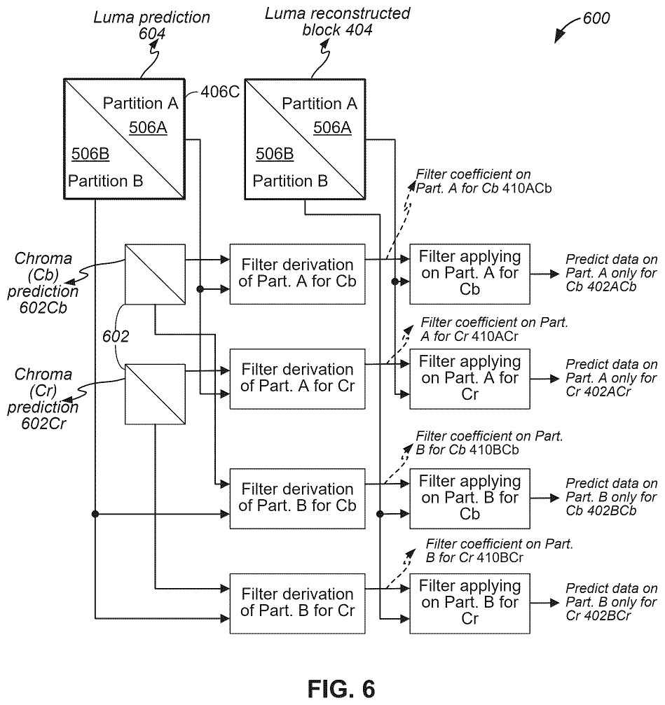

FIG. 6 is a flow diagram of an image decoding process 600 of determining CCP model parameters 410 based on prediction samples 602 and 604 (e.g., in an intra block copying mode), in accordance with some embodiments. A current coding block 406C includes a plurality of partitions 506 (e.g., a first partition 506A, a second partition 506B) in a multi-partition prediction mode 504 (also called a multiple prediction block mode). Each of the plurality of partitions 506 corresponds to a set of respective model parameters 410 for reconstructing a respective chroma sample 402 based on a set of respective luma samples 404. Each respective chroma sample 402 includes a respective Cb chroma sample 402Cb and a respective Cb chroma sample 402Cr. Referring to FIG. 6, for each of the plurality of partitions 506, the set of respective model parameters 410 are determined based on chroma prediction samples 602 and luma prediction samples 604 of the respective partition 506. Each chroma prediction sample 602 includes a Cb chroma prediction sample 602Cb and a Cb chroma prediction sample 602Cr. For each partition, the luma prediction samples 604 and the Cb chroma prediction sample 602Cb are applied to determine the set of respective model parameters 410 for reconstructing the respective Cb chroma sample 402Cb, and the luma prediction samples 604 and the Cr chroma prediction sample 602Cr are applied to determine the set of respective model parameters 410 for reconstructing the respective Cr chroma sample 402Cr.

In some embodiments, four sets of respective model parameters 410ACb, 410ACr, 410BCb, and 410BCr are derived for reconstructing the respective Cb chroma sample 402ACb of the first partition 506A, the respective Cr chroma sample 402ACr of the first partition 506A, the respective Cb chroma sample 402BCb of the second partition 506B, and the respective Cr chroma sample 402BCr of the second partition 506B, respectively.

In some embodiments, the decoder 122 determines that the current coding block 406C is coded in one of an inter prediction mode, an intra block copying mode, and an intra template-matching based prediction mode.

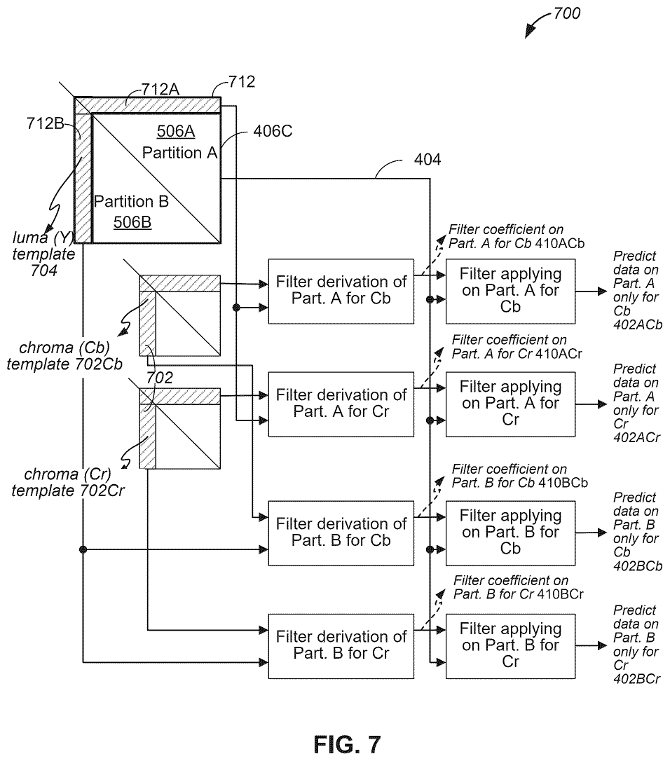

FIG. 7 is a flow diagram of another image decoding process 700 of determining CCP model parameters 410 based on samples of a reference area 412 (e.g., in an intra template-matching based prediction mode), in accordance with some embodiments. In some embodiments, the current coding block 406C is immediately adjacent to a template area 712 (e.g., a reference area 412) including a first template region 712A (e.g., a top reference region 412T), and the first template region 712A is immediately adjacent to the first partition 506A. The set of first model parameters 410A used by the first partition is determined based on reference samples of the first template region 712A. Further, in some embodiments, the template area 712 further includes a second template region 712B immediately adjacent to a second partition 506B of the current coding block 406C. A set of second model parameters 410B is determined based on reference samples of the second template region 712B, and applied to reconstruct a second chroma sample 402B of the second partition 506B based on a set of second luma samples 404B.

Referring to FIG. 7, for each of the plurality of partitions 506, the set of respective model parameters 410 are determined based on chroma prediction samples 702 and luma prediction samples 704 of a respective subset of the template area 712. Each chroma prediction sample 702 includes a Cb chroma prediction sample 702Cb and a Cb chroma prediction sample 702Cr. For each partition 506, the luma prediction samples 704 and the Cb chroma prediction sample 702Cb are applied to determine the set of respective model parameters 410 for reconstructing the respective Cb chroma sample 402Cb, and the luma prediction samples 704 and the Cr chroma prediction sample 702Cr are applied to determine the set of respective model parameters 410 for reconstructing the respective Cr chroma sample 402Cr.

In some embodiments, four sets of respective model parameters 410ACb, 410ACr, 410BCb, and 410BCr are derived for reconstructing the respective Cb chroma sample 402Cb of the first partition 506A, the respective Cr chroma sample 402Cr of the first partition 506A, the respective Cb chroma sample 402Cb of the second partition 506B, and the respective Cr chroma sample 402Cr of the second partition 506B, respectively. For the first partition 506A, the set of respective model parameters 410ACb is derived based on the luma prediction samples 704 and the Cb chroma prediction sample 702Cb of the first template region 712A, and the set of respective model parameters 410ACr is derived based on the luma prediction samples 704 and the Cr chroma prediction sample 702Cr of the first template region 712A.

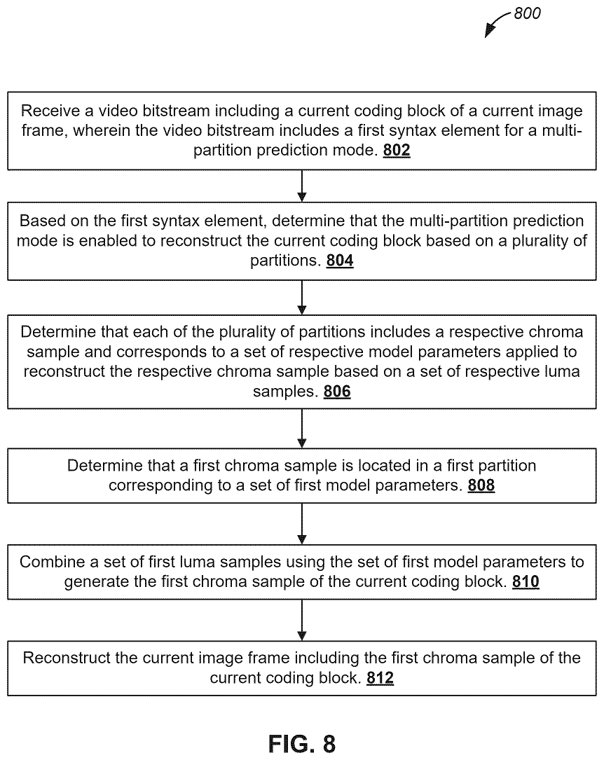

FIG. 8 is a flow diagram illustrating an example method 800 of decoding video, in accordance with some embodiments. The method 800 may be performed at a computing system (e.g., the server system 112, the source device 102, or the electronic device 120) having control circuitry and memory storing instructions for execution by the control circuitry. In some embodiments, the method 800 is performed by executing instructions stored in the memory (e.g., the memory 314) of the computing system. In some embodiments, the method 900 is applied jointly with one or more video codecs, including but not limited to, H.264, H.265/HEVC, H.266/VVC, AV1 and AVS/AVS2/AVS3. Some implementations are directed to applying more than one cross-component prediction model, e.g., when the coding block is coded in any method that allows multiple prediction blocks (e.g. GPM mode, inter prediction unit in HEVC) and a CCP control flag of cross-component prediction is enabled. For example, each partition 506 (e.g. geometric partition) has its own cross-component model (e.g. in GPM mode, inter prediction unit in HEVC), and corresponds to partition-based model parameters 410 for CCP. The corresponding cross-component model is applied on the luma samples 404 in the corresponding geometric partition 506 to predict the chroma sample 402.

In some embodiments, the partition-based model parameters 410 are implicitly applied without any signaling. In some embodiments, a control flag (e.g., a second syntax element 512) is signaled to control whether the partition-based model parameters 410 is applied or not for CCP. The partition-based model parameters 410 are applied when the control flag is true; Otherwise, the partition-based model parameters 410 is not applied, and a CCP model which is similar to the existing cross-component prediction method for the inter prediction block is derived from the luma prediction samples and chroma predictions of the current coding block 406C. The derived model CCP corresponds to a set of block-level model parameters, and is applied on the entire current coding block 406C.

In some embodiments, the cross-component prediction model is derived from the corresponding partition 506 (e.g. geometric partition) in the luma prediction block 604 and the chroma prediction block 602, when the current coding block 406C is coded in inter prediction mode, intra block copying mode, intra template-matching based prediction mode. FIG. 6 is an example of cross-component prediction derivation by using prediction data of luma samples 604 and chroma samples 602. Model samples 410 of the corresponding derived model is applied on chroma block when the current coding block is coded in a GPM mode. In some embodiments, the cross-component prediction 702 or 704 is not used implicitly for a partition 506 (e.g. geometric partition) when the sample size 516 of luma or chroma prediction block in the associated geometric partition is smaller than and/or is equal to a threshold value 518. The threshold value 518 can be a predefined value, and this predefined value can be different according to the coding block size 522.

In some embodiments, partition-based model parameters 410 are not used implicitly for the current coding block 406C when the sample size 516 of luma or chroma prediction block 702 or 704 in the one of two or more partitions 506 (e.g. geometric partitions) is smaller than and/or is equal to a threshold value 518. The threshold value 518 can be a predefined value, and this predefined value can be different according to the coding block size 522.

In some embodiments, model parameters 410 of the corresponding cross-component model for each partition 506 (e.g. geometric partition) is derived based on the partition 506 (e.g. geometric partition) split on the template area 712 and the model for each partition 506 (e.g. geometric partition) is derived from the corresponding luma template and chroma template which are constructed from the reconstructed neighboring samples. FIG. 7 shows an example of cross-component prediction, where the cross-component prediction model is derived by using samples of a template area 712. In some embodiments, the cross-component prediction is not used implicitly for a partition 506 (e.g. geometric partition) when the sample size 516 of the associated luma or chroma template size for that partition 506 (e.g. geometric partition) is smaller than and/or is equal to a threshold value 518. The threshold value 518 can be a predefined value, and this predefined value can be different according to the coding block size 522.

In some embodiments, partition-based model parameters 410 are not used implicitly for the current coding block 406C when the sample size 516 of the luma or chroma template 712 in one of two or more partitions 506 (e.g. geometric partitions) is smaller than and/or is equal to a threshold value 518.

Some implementations are directed to disabling cross-component prediction when a multiple-partition prediction mode 504 (such as GPM mode, inter prediction unit in HEVC) is used in luma prediction block. The control flag (e.g., the second syntax element 512) for cross-component prediction is not signaled and set as false in default when a multiple prediction mode 504 (such as GPM mode, inter prediction unit in HEVC) is used in luma prediction block. In some embodiments, the CCP mode 520 is disabled for a chroma coding block (e.g., of a second coding block 406B) when the luma prediction block with a multiple prediction mode (e.g. GPM mode) is part of the collocated luma block and the dual-tree mode 524 is enabled. In some embodiments, the CCP mode 520 is disabled for a chroma coding block (e.g., of a second coding block 406B) in dual-tree case when the luma prediction block with a multiple prediction mode 504 (e.g. GPM mode) is part of the collocated luma block and the size 516 of the luma partition (e.g. GPM) block is larger than and/or equal to a threshold value 518, where the threshold value may a predefined value that depends on the coding chroma block size 522. In some embodiments, the CCP mode 520 is disabled for a chroma coding block (e.g., of a second coding block 406B) in a single-tree mode 526 when the coding block 406B is encoded in a multiple-partition prediction mode 504 (e.g., GPM).

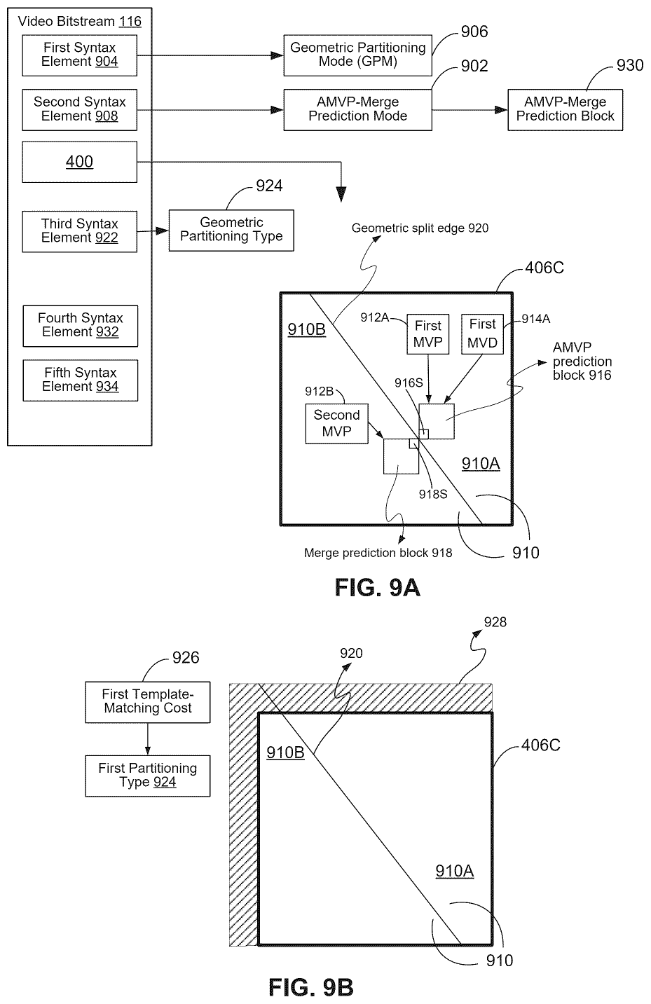

Although FIG. 9 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

### Turning Now to Some Example Embodiments.

(A1) In some implementations, a method 800 is implemented for decoding video data. The method 800 includes receiving (operation 802) a video bitstream including a current coding block of a current image frame, wherein the video bitstream includes a first syntax element for a multi-partition prediction mode; based on the first syntax element, determining (operation 804) that the multi-partition prediction mode is enabled to reconstruct the current coding block based on a plurality of partitions; determining (operation 806) that each of the plurality of partitions includes a respective chroma sample and corresponds to a set of respective model parameters applied to reconstruct the respective chroma sample based on a set of respective luma samples; determining (operation 808) that a first chroma sample is located in a first partition corresponding to a set of first model parameters; combining (operation 810) a set of first luma samples using the set of first model parameters to generate the first chroma sample of the current coding block; and reconstructing (operation 812) the current image frame including the first chroma sample of the current coding block.

(A2) In some implementations of A1, the method 800 further includes determining that a second chroma sample is located in a second partition corresponding to a set of second model parameters; and combining a set of second luma samples using the set of second model parameters to generate the second chroma sample of the current coding block, the current image frame is reconstructed based on both the first chroma sample and the second chroma sample of the current coding block; the set of first model parameters is distinct from the set of second mode parameters.

(A3) In some implementations of A2, the set of first model parameters of the first partition corresponds to a first filter shape, and the set of second model parameters of the second partition corresponds to a second filter shape distinct from the first filter shape.

(A4) In some implementations of A2, both the set of first model parameters of the first partition and the set of second model parameters of the second partition correspond to a first filter shape, and at least one of the set of first model parameters is different from a respective one of the set of second model parameters.

(A5) In some implementations of A1-A4, the multi-partition prediction mode indicated by the first syntax element includes a geometric partitioning mode (GPM), and the first syntax element indicates that the GPM is enabled to apply non-rectangular partitioning to the current coding block and create in the plurality of partitions.

(A6) In some implementations of A1-A5, at least two different sets of model parameters are applied to the plurality of partitions of the current coding block, independently of a plurality of syntax elements included in the video bitstream.

(A7) In some implementations of A1-A5, the video bitstream includes a second syntax element for a partition-based cross-component prediction (CCP) mode, the second syntax element indicating that the partition-based CCP mode is enabled to apply two or more sets of model parameters to the plurality of partitions of the current coding block.

(A8) In some implementations of A1-A5, the video bitstream includes a third syntax element for a partition-based CCP mode, the method the method 800 further includes determining that the third syntax element indicates that the partition-based CCP mode is disabled for a first coding block; and apply a set of block-level model parameters to a plurality of partitions of the first coding block.

(A9) In some implementations of A1-A8, the method 800 further includes determining that the current coding block is coded in one of an inter prediction mode, an intra block copying mode, and an intra template-matching based prediction mode.

(A10) In some implementations of A1-A9, wherein: the current coding block is immediately adjacent to a template area including a first template region, and the first template region is immediately adjacent to the first partition. The set of first model parameters is determined based on reference samples of the first template region.

(A11) In some implementations of A10, wherein: the template area further includes a second template region immediately adjacent to a second partition of the current coding block; and a set of second model parameters is determined based on reference samples of the second template region, and applied to reconstruct a second chroma sample of the second partition based on a set of second luma samples.

(A12) In some implementations of A1-A5, the method 800 further includes in accordance with a determination that a sample size of luma samples of the first partition is equal to or lower than a sample size threshold, determining that the video bitstream includes a fourth syntax element for a CCP mode, the fourth syntax element indicating that the CCP mode is enabled to reconstruct the first chroma sample of the first partition based on the set of first luma samples.

(A13) In some implementations of A12, the method 800 further includes determining a coding block size of the current coding block; and determining the sample size threshold based on the coding block size.

(A14) In some implementations of A1-A5, the method 800 further includes in accordance with a determination that a sample size of luma samples of at least one of the plurality of partitions is equal to or lower than a sample size threshold, determining that the video bitstream includes a second syntax element for a partition-based CCP mode, the second syntax element indicating that the partition-based CCP mode is enabled to apply two or more sets of model parameters to the plurality of partitions of the current coding block.

(A15) In some implementations of A14, the method 800 further includes determining a coding block size of the current coding block; and determining the sample size threshold based on the coding block size.

(A16) In some implementations of A1-A15, the current image frame further includes a second coding block distinct form the current coding block, the method the method 800 further includes in accordance with a determination that the multi-partition prediction mode is enabled for luma samples of the second coding block and that a dual-tree mode is enabled, disabling cross component prediction for reconstructing chroma samples of the second coding block.

(A17) In some implementations of A1-A15, the current image frame further includes a second coding block distinct form the current coding block, the method the method 800 further includes in accordance with a determination that the multi-partition prediction mode is enabled for luma samples of the second coding block, that a dual-tree mode is enabled, and that a sample size of the luma samples of the second coding block is greater than or equal to a sample size threshold, disabling cross component prediction for reconstructing chroma samples of the second coding block.

(A18) In some implementations of A17, the method 800 further includes determining a coding block size of the second coding block; and determining the sample size threshold based on the coding block size of the second coding block.

(A19) In some implementations of A1-A15, the current image frame further includes a second coding block distinct form the current coding block, the method the method 800 further includes in accordance with a determination that the multi-partition prediction mode is enabled for luma samples of the second coding block and that a single-tree mode is enabled for chroma samples of the second coding block, disabling cross component prediction for reconstructing chroma samples of the second coding block.

(A20) In some implementations of A1-A19, the method 800 further includes in accordance with a determination that a GPM is enabled for the current coding block, determining that the current coding block is reconstructed based on a plurality of partitions.

(A21) In some implementations, a method is implemented for encoding video data. The method 900 includes receiving video data including a current image frame, the current image frame includes a current coding block; encoding the current image frame; transmitting the encoded current image frame via a video bitstream; and signaling, via the video bitstream, the current image frame and a first syntax element for a multi-partition prediction mode; when the multi-partition prediction mode is enabled, the current coding block is reconstructed based on a plurality of partitions, and each of the plurality of partitions include a respective chroma sample and a set of respective luma samples, and corresponds to a set of respective model parameters applied to reconstruct the respective chroma sample based on the set of respective luma samples.

(A22) In some embodiments of A21, the method is implemented to enable the features of any of A2-A20.

(A23) In some implementations, a method of bitstream conversion is implemented. The method 900 includes obtaining a source video sequence including a current image frame; and performing a conversion between the source video sequence and a video bitstream, the video bitstream comprises the current image frame that further includes a current coding block and a first syntax element for a multi-partition prediction mode; and when the multi-partition prediction mode is enabled, the current coding block is reconstructed based on a plurality of partitions, and each of the plurality of partitions include a respective chroma sample and a set of respective luma samples, and corresponds to a set of respective model parameters applied to reconstruct the respective chroma sample based on the set of respective luma samples.

(A24) In some embodiments of A23, the method is implemented to enable the features of any of A2-A20.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A24 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A24 above).

FIG. 9A illustrates an example current coding block 406C coded with an AMVP-merge prediction mode 902, in accordance with some embodiments, and FIG. 9B illustrates another example current coding block 406C having a reference area 412 and coded with an AMVP-merge prediction mode 902, in accordance with some embodiments. An encoder 106 of a source device 102 (FIG. 1) obtains a source video sequence including a current image frame 400 and performs a conversion between the source video sequence and a video bitstream 108. The video bitstream 108 includes the current image frame 400 that further includes the current coding block 406C, a first syntax element 904 for a geometric partitioning mode (GPM) 906, and a second syntax element 908 for the AMVP-merge prediction mode 902. In some embodiments, the video bitstream 108 is forwarded as a video bitstream 116 by a server system 112. A decoder 122 of an electronic device 102-1 (FIG. 1) receives the video bitstream 116 including the current coding block 406C of the current image frame 400, and the video bitstream 116 includes the first syntax element 904 and the second syntax element 908.

The decoder 122 receives a video bitstream 116 including a current image frame 400 including a current coding block 406C. The video bitstream 116 includes a first syntax element 904 for a geometric partitioning mode (GPM) 906 and a second syntax element 908 for the AMVP-merge prediction mode 902. Based on the first syntax element 904 and the second syntax element 908, the decoder 122 determines that the GPM is enabled to apply non-rectangular partitioning to the current coding block 406C and that the AMVP-merge prediction mode 902 is enabled to apply AMVP on at least one of a plurality of partitions 910 of the current coding block 406C. A first motion vector prediction (MVP) 912A and a first motion vector difference (MVD) 914A are extracted from the video bitstream 116 for a first partition 910A of the plurality of partitions 910 of the current coding block 406C. An AMVP prediction block 916 for the first partition 910A of the current coding block 406C is generated based on the first MVP 912A and the first MVD 914A. The decoder 122 reconstructs the current image frame 400 including the current coding block 406C based on the AMVP prediction block 916 of the first partition 910A.

In some embodiments, the decoder 122 extracts, from the video bitstream 116, a second MVP 912B for a second partition 910B of the plurality of partitions of the current coding block 406C, and determines a merge prediction block 918 for the second partition 910B of the current coding block 406C based on the second MVP. The current coding block 406C is reconstructed based on both the AMVP prediction block 916 of the first partition 910A and the merge prediction block 918 of the second partition 910B. Further, in some embodiments, the second MVP 912B of the second partition 910B corresponds to a second prediction direction different from a first prediction direction to which the first MVP 912A of the first partition 910A corresponds. Referring to FIG. 9, the current coding block 406C is divided into the first partition 910A and the second partition 910B by a geometric split edge 920.

In some embodiments, the second partition 910B is immediately adjacent to the first partition 910A. When the decoder 122 reconstructs the current image frame 400, the decoder 122 blends first samples 916S of the AMVP prediction block 916 of the first partition 910A and second samples 918S of the merge prediction block 918 of the second partition 910B. The first samples 916S and the second samples 918S are immediately adjacent to a boundary (e.g., geometric split edge 920) separating the first partition 910A and the second partition 910B.

In some embodiments, the video bitstream 116 further includes a third syntax element 922 for selecting one of a plurality of predefined geometric partitioning types, e.g., determining a first partitioning type 924. The decoder 122 identifies the first partition 910A based on the one of the plurality of geometric partitioning types selected by the third syntax element 922. Further, in some embodiments, each of the plurality of predefined geometric partitioning types is defined according to a location of a geometric split edge 920 and types of resulting partitions (e.g., a foreground partition, a background partition). Further, in some embodiments, the current coding block 406C is immediately adjacent to a reference area 928 located in the current image frame 400. The plurality of predefined geometric partitioning types correspond to a plurality of template-matching costs determined based on reference samples in the reference area. A first template-matching cost 926 corresponds to the selected one of the predefined geometric partitioning types, and is the smallest among the plurality of template-matching costs.

In some embodiments, the current coding block 406C is immediately adjacent to a reference area 928 located in the current image frame 400. The decoder 122 determines a plurality of template-matching costs corresponding to a plurality of predefined geometric partitioning types based on reference samples in the reference area 928. A first template-matching cost 926 of a first partitioning type 924 is the smallest among those of the plurality of predefined geometric partitioning types. The first partitioning type 924 of the plurality of predefined geometric partitioning types is selected to generate the first partition 910A.

In some embodiments, the first syntax element 904 includes a first one-bit flag indicating whether the GPM 906 is enabled. In some embodiments, the second syntax element 908 includes a second one-bit flag indicating whether that the AMVP-merge prediction mode 902 is enabled. In some embodiments, the video bitstream 116 further includes a fourth syntax element 932 for identifying the first MVP and a fifth syntax element 934 for identifying the first MVD.

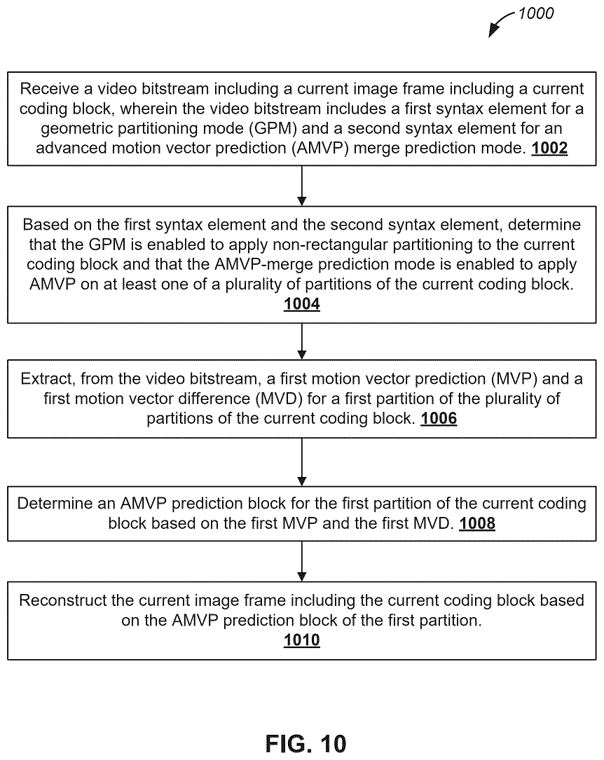

FIG. 10 is a flow diagram illustrating an example method 1000 of decoding video, in accordance with some embodiments. The method 1000 may be performed at a computing system (e.g., the server system 112, the source device 102, or the electronic device 120) having control circuitry and memory storing instructions for execution by the control circuitry. In some embodiments, the method 1000 is performed by executing instructions stored in the memory (e.g., the memory 314) of the computing system. In some embodiments, the method 900 is applied jointly with one or more video codecs, including but not limited to, H.264, H.265/HEVC, H.266/VVC, AV1 and AVS/AVS2/AVS3. Some implementations are directed to applying a geometric partition mode 906 jointly with an AMVP-merge prediction mode 902. More specifically, two geometric partitions 910A and 910B of a current coding block 406C are predicted from a AMVP prediction block 916 and a merge prediction block 918, respectively, and fused together via GPM blending method when the geometric partition mode 906 is applied with the AMVP-merge prediction mode 902 in the current coding block 406C (also called an AMVP-merge prediction block 930). FIG. 9A shows an example of the GPM 906 applied on the AMVP-merge prediction block 930 which fuse two prediction blocks corresponding to the AMVP prediction block 916 and merge prediction block 918.

In some embodiments, a flag (e.g., a first syntax element 904) is signaled to indicate whether the geometric partition mode 906 is applied on the AMVP-merge prediction block 930 or not. The geometric partition mode 906 is applied on the AMVP-merge prediction mode 902 when the flag is true.

In some embodiments, a syntax (e.g., a first syntax element 904) is signaled to indicate which geometric partition mode 906 is selected. The geometric partition mode 906 is signaled in the video bitstream 116 to indicate the geometric split edge 920 to determine which partition 910 is predicted from the AMVP prediction block 916 and which partition 910 is predicted from the merge prediction 918.

Referring to FIG. 9B, in some embodiments, all possible geometric partition modes are constructed in a list, the template-matching method is applied on template by using all possible geometric partition modes to obtain the template-matching costs, and then these template-matching costs are reordered by ascending order. The syntax (e.g., third syntax element 922) in the video bitstream 116 is signaled to indicate which index in the sorted list is used for geometric partition mode 906.

In some embodiments, a flag is signaled to indicate which prediction direction AMVP should be applied. For example, a reference index and MVD are further signaled for signaled prediction direction, e.g., via syntax elements 932 and 934. In some embodiments, merged prediction (e.g., the merge prediction block 918) is predicted from another prediction direction which is not used to for AMVP prediction (e.g., the AMVP prediction block 916).

In some embodiments, a merged candidate list is constructed for prediction direction of the merge prediction block 918. The merge candidate is derived from the spatial adjacent neighboring candidate, spatial non-adjacent candidate, and/or temporal candidate. Further, in some embodiments, only the candidate which has the motion information on the prediction direction for the merge prediction block 918 can be inserted in the candidate list. In an example, the merge prediction block 918 is predicted from reference list Lx. Only the candidate which has the motion information from reference list Lx can be inserted into the merge candidate list. Stated another way, this candidate either be a bi-prediction or a uni-prediction at reference list Lx. When the candidate is bi-prediction, only the motion information in reference list Lx is used for list construction. In some embodiments, only the candidate is a uni-prediction and the prediction direction is identical to the prediction direction for the merge prediction block 918 in the GPM 906 is used for merge list construction.

In some embodiments, the merged candidate list for the merge prediction block 918 is constructed using regular merge candidate list construction without any prediction direction restriction. More specifically, the merge motion vector in the merge candidate list can be predicted from any prediction direction or bi-direction.

In some embodiments, template-matching method can be applied on all combinations of geometric partition modes and merged motion vectors in the merge list to generate a sorted list by using the template-matching in ascending order. An index is signaled to indicate which combination of the geometric partition mode and the merged candidate is selected for the given MVD and reference index in AMVP part.

In some embodiments, GPM blending method is applied to combine samples of the merge prediction block 918 and the AMVP prediction block 916 that are located immediately adjacent to the geometric split edge 920. Further, in some embodiments, an adaptive blending width (e.g., a number of samples) can be applied in the GPM 906, and a syntax is further signaled to indicate which blending width is used. Further, in some embodiments, a set of adaptive blending widths may be adaptively applied based on a block shape and/or a block size.

In some embodiments, a regression-based GPM can be applied to the AMVP-merge prediction block 930 (e.g., the current coding block 406C). The geometric partition type 924 is derived from a template (e.g., a reference area 928) using linear regression. Further, in some embodiments, a flag is signaled to indicate whether this regression-based GPM is used or not. Additionally, in some embodiments, the regression-based GPM mode is available only when the GPM flag (e.g., the first syntax element 904) is enabled. Stated another way, the regression-based GPM is a sub-mode of the GPM 906 in AMVP-merge prediction.

Although FIG. 10 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

### Turning Now to Some Example Embodiments.

(B1) In some embodiments, a method 1000 is implemented for decoding video data. The method 1000 includes receiving (operation 1002) a video bitstream including a current image frame including a current coding block, wherein the video bitstream includes a first syntax element for a geometric partitioning mode (GPM) and a second syntax element for an advanced motion vector prediction (AMVP) merge prediction mode; based on the first syntax element and the second syntax element, determining (operation 1004) that the GPM is enabled to apply non-rectangular partitioning to the current coding block and that the AMVP-merge prediction mode is enabled to apply AMVP on at least one of a plurality of partitions of the current coding block; extracting (operation 1006), from the video bitstream, a first motion vector prediction (MVP) and a first motion vector difference (MVD) for a first partition of the plurality of partitions of the current coding block; determining (operation 1008) an AMVP prediction block for the first partition of the current coding block based on the first MVP and the first MVD; and reconstructing (operation 1010) the current image frame including the current coding block based on the AMVP prediction block of the first partition.

(B2) In some embodiments of B1, the method 1000 further includes extracting, from the video bitstream, a second MVP for a second partition of the plurality of partitions of the current coding block; and determining a merge prediction block for the second partition of the current coding block based on the second MVP, wherein the current coding block is reconstructed based on both the AMVP prediction block of the first partition and the merge prediction block of the second partition.

(B3) In some embodiments of B2, the second MVP of the second partition corresponds to a second prediction direction different from a first prediction direction to which the first MVP of the first partition corresponds.

(B4) In some embodiments of any of B1-B3, the second partition is immediately adjacent to the first partition, and reconstructing the current image frame further includes blending first samples of the AMVP prediction block of the first partition and second samples of the merge prediction block of the second partition, the first samples and the second samples being immediately adjacent to a boundary separating the first partition and the second partition.

(B5) In some embodiments of any of B1-B4, the video bitstream further includes a third syntax element for selecting one of a plurality of predefined geometric partitioning types. The method 1000 further includes identifying the first partition based on the one of the plurality of geometric partitioning types selected by the third syntax element.

(B6) In some embodiments of B4, each of the plurality of predefined geometric partitioning types is defined according to a location of a geometric partition split edge and types of resulting partitions.

(B7) In some embodiments of B4, the current coding block is immediately adjacent to a reference area located in the current image frame; the plurality of predefined geometric partitioning types correspond to a plurality of template-matching costs determined based on reference samples in the reference area; a first template-matching cost corresponds to the selected one of the predefined geometric partitioning types, and is the smallest among the plurality of template-matching costs.

(B8) In some embodiments of any of B1-B7, the current coding block is immediately adjacent to a reference area located in the current image frame. The method 1000 further includes determining a plurality of template-matching costs corresponding to a plurality of predefined geometric partitioning types based on reference samples in the reference area; determining a first template-matching cost of a first partitioning type is the smallest among those of the plurality of predefined geometric partitioning types; and selecting the first partitioning type of the plurality of predefined geometric partitioning types to generate the first partition.

(B9) In some embodiments of any of B1-B8, the first syntax element includes a first one-bit flag indicating whether the GPM is enabled.

(B10) In some embodiments of any of B1-B9, the second syntax element includes a second one-bit flag indicating whether that the AMVP-merge prediction mode is enabled.

(B11) In some embodiments of any of B1-B10, the video bitstream further includes a fourth syntax element for identifying the first MVP and a fifth syntax element for identifying the first MVD.

(B12) In some embodiments, a method of video encoding is implemented. The method includes receiving video data including a current image frame, wherein the current image frame includes a current coding block; encoding the current image frame; transmitting the encoded current image frame via a video bitstream; and signaling, via the video bitstream, the video bitstream includes the current image frame, a first syntax element indicating whether a geometric partition mode (GPM) is enabled to apply non-rectangular partitioning to the current coding block, and a second syntax element indicating whether an advanced motion vector prediction (AMVP) merge prediction mode is enabled to apply AMVP on at least one of a plurality of partitions of the current coding block; wherein when both the GPM and the BVP-merge prediction mode are enabled, the current image frame is reconstructed by extracting, from the video bitstream, a first motion vector prediction (MVP) and a first motion vector difference (MVD) for a first partition of the current coding block and determining an AMVP prediction block for the first partition of the current coding block based on the first MVP and the first MVD.

(B13) In some embodiments of B12, the method is implemented to enable the features of any of B2-B11.

(B14) In some embodiments, a method of bitstream conversion is implemented. The method includes obtaining a source video sequence including a current image frame; and performing a conversion between the source video sequence and a video bitstream, wherein the video bitstream comprises: the current image frame that further includes a current coding block; a first syntax element indicating whether a geometric partition mode (GPM) is enabled to apply non-rectangular partitioning to the current coding block; and a second syntax element indicating whether an advanced motion vector prediction (AMVP) merge prediction mode is enabled to apply AMVP on at least one of a plurality of partitions of the current coding block; wherein when both the GPM and the BVP-merge prediction mode are enabled, the current image frame is reconstructed by extracting, from the video bitstream, a first motion vector prediction (MVP) and a first motion vector difference (MVD) for a first partition of the current coding block and determining an AMVP prediction block for the first partition of the current coding block based on the first MVP and the first MVD.

(B15) In some embodiments of B14, the method is implemented to enable the features of any of B2-B11.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., B1-B15 above).

In yet another aspect, some embodiments include a non-transitory computer-readable storage medium storing one or more sets of instructions for execution by control circuitry of a computing system, the one or more sets of instructions including instructions for performing any of the methods described herein (e.g., B1-B15 above).

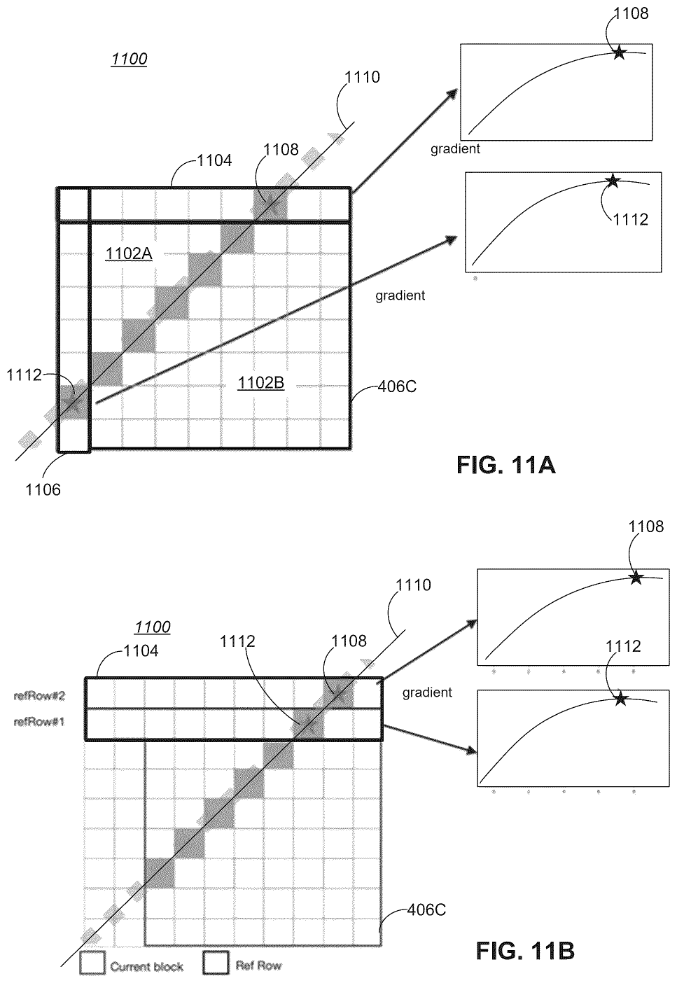

FIGS. 11A and 11B are diagrams illustrating an example method 1100 of determining a geometric split edge 1110 that splits a current coding block 406C to two partitions 1102A and 1102B in a GPM, in accordance with some embodiments. Referring to FIG. 11A, in some embodiments, a reference row 1104 and a reference column 1106 are applied to determine the geometric split edge 1110. Further, in some embodiments, a first maximum gradient sample 1108 is found on the reference row 1104, and a second maximum gradient sample 1112 is found on the reference column 1106. A line passing these two maximum gradient samples 1108 and 1112 are used as the geometric split edge 1110, which splits the current coding block 406C to the two partitions 1102A and 1102B. In some embodiments, the reference row 1104 includes a first neighboring row of samples that is immediately adjacent to the current coding block 406C, e.g., when the first neighboring row and another row above the first neighboring row have different characteristic. For example, a second neighboring row that is immediately above the first neighboring row, and a difference of a certain characteristic (e.g., luma value) of the first and second neighboring rows exceeds a difference threshold.

Referring to FIG. 11B, in some embodiments, two reference rows 1104 are applied to determine the geometric split edge 1110. Further, in some embodiments, two maximum gradient sample 1108 and 1112 are found on the two reference rows 1104. A line passing these two maximum gradient samples 1108 and 1112 are used as the geometric split edge 1110, which splits the current coding block 406C to the two partitions 1102A and 1102B. It is noted that in some embodiments not shown, two reference columns 1106 are applied to determine the geometric split edge 1110.

In some embodiments, a plurality of reference rows 1104 and a plurality of reference columns 1106 are available. Only a line derived from the plurality of reference rows 1104 or a line derived from the plurality of reference columns 1106 is used as the geometric split edge 1110 for splitting the current coding block 406C. In an example, the video bitstream 116 includes a flag used to select the line derived from the plurality of reference rows 1104 or the line derived from the plurality of reference columns 1106 as the geometric split edge 1110. Alternatively, in another example, the video bitstream 116 does not signal any flag, and one of the line derived from the plurality of reference rows 1104 or the line derived from the plurality of reference columns 1106 is dynamically selected as the geometric split edge 1110.

In some embodiments, two reference rows 1104 or two reference columns 1106 are immediately adjacent to the current coding block 406C, and applied to determine the geometric split edge 1110. One or more reference rows or columns located further from the current coding block 406C are used as a template to verify the geometric split edge 1110 and associated partitions 1102A and 1102B.

In some embodiments, more than two peak samples are available. Each peak sample is located on a respective reference row 1104 or column 1106, and corresponds to a maximum gradient sample among a set of samples located on the respective referenced row 1104 or column 1106. The line corresponding to the geometric split edge 1110 is derived by curve fitting based on locations of the more than two peak samples. Further, in some embodiments, a higher degree poly function is used to derive non-linear partitions.

In some embodiments, the reference row(s) 1104 or column(s) 1106 do not include maximum gradient sample(s) 1108 or 1112, and determination of the geometric split edge 1110 is aborted. Further, in some embodiments, sample values on a reference row 1104 or column 1106 varies up and down between a sample range, and the reference row 1104 or 1106 does not include a maximum gradient sample. Stated in another way, in some embodiments, a higher order of sample value indicates a number of peak samples more than a threshold on the reference row 1104 or column 1106.

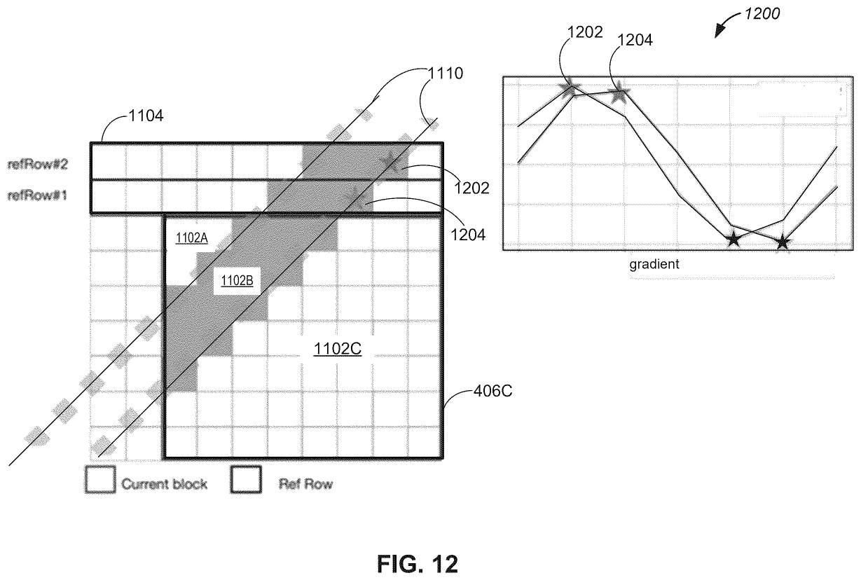

FIG. 12 is a diagram illustrating an example method 1200 of determining a plurality of geometric split edges 1110 that split a current coding block 406C to more than two partitions 1102A and 1102B in a GPM, in accordance with some embodiments. Two or more partition lines 1110 are derived and split the current coding block 406C into more than two partitions 1102. Two available MVs may be used to fill the different areas separately. In some embodiments, partition lines (e.g., geometric split edges 1110) are derived based on reference rows 1104 and reference columns 1106. In an example, the reference rows 1104 may derive a partition, and the reference columns 1106 may derive another partition. When these two partitions are different enough, they may be use separately.

In some embodiments, when a difference between two largest gradient samples meets a criterion, two partition lines (e.g., two geometric split edges 1110 on FIG. 12) are derived. In an example, as FIG. 12 shown, the two partitions are derived from each reference row 1104, and two lines are derived by connecting two peak gradient positions 1202 and 1204. Further, in some embodiments, when a first gradient curve of a first reference row and a second gradient curve of a second reference row are substantially close and much larger than others, multiple partitions (e.g., partitions 1102A-1102C in FIG. 11B) are available. In an example, a first motion vector may be used for two partitions 1102A and 1102C, and a second motion vector is used for a partition 1102B.

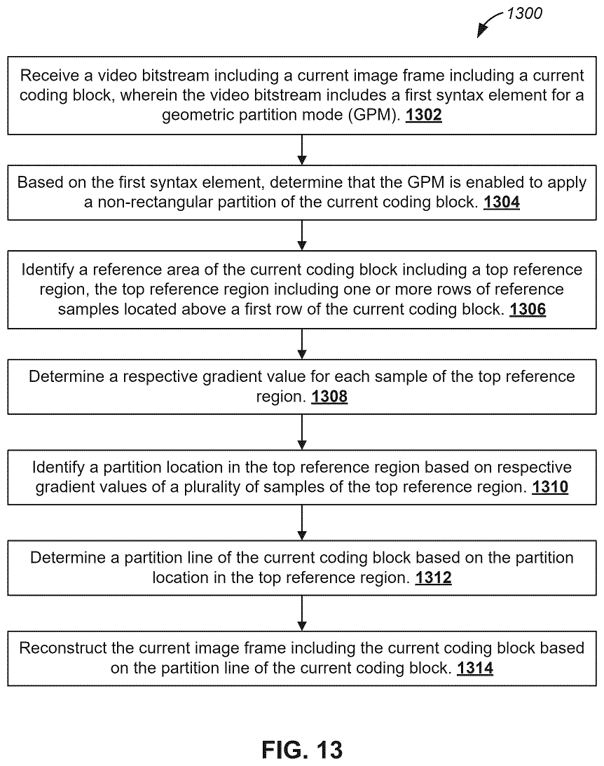

FIG. 13 is a flow diagram illustrating an example method 1300 of decoding video, in accordance with some embodiments. The method 1300 may be performed at a computing system (e.g., the server system 112, the source device 102, or the electronic device 120) having control circuitry and memory storing instructions for execution by the control circuitry. In some embodiments, the method 1300 is performed by executing instructions stored in the memory (e.g., the memory 314) of the computing system. In some embodiments, the method 1300 is applied jointly with one or more video codecs, including but not limited to, H.264, H.265/HEVC, H.266/VVC, AV1 and AVS/AVS2/AVS3.

Some implementations are directed to video decoding. The method 1300 receiving (operation 1302) a video bitstream including a current image frame including a current coding block, wherein the video bitstream includes a first syntax element for a GPM; based on the first syntax element, determining (operation 1304) that the GPM is enabled to apply a non-rectangular partition of the current coding block; identifying (operation 1306) a reference area of the current coding block including a top reference region, the top reference region including one or more rows of reference samples located above a first row of the current coding block; determining (operation 1308) a respective gradient value for each sample of the top reference region; identifying (operation 1310) a partition location in the top reference region based on respective gradient values of a plurality of samples of the top reference region; determining (operation 1312) a partition line of the current coding block based on the partition location in the top reference region; and reconstructing (operation 1314) the current image frame including the current coding block based on the partition line of the current coding block.

Although FIG. 13 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method for decoding video data, comprising:
receiving a video bitstream including a current coding block of a current image frame, wherein the video bitstream includes a first syntax element for a multi-partition prediction mode;
based on the first syntax element, determining that the multi-partition prediction mode is enabled to reconstruct the current coding block based on a plurality of partitions;
determining that each of the plurality of partitions includes a respective chroma sample and corresponds to a set of respective model parameters applied to reconstruct the respective chroma sample based on a set of respective luma samples;
determining that a first chroma sample is located in a first partition corresponding to a set of first model parameters;
combining a set of first luma samples using the set of first model parameters to generate the first chroma sample of the current coding block; and
reconstructing the current image frame including the first chroma sample of the current coding block.

2. The method of claim 1, further comprising:
determining that a second chroma sample is located in a second partition corresponding to a set of second model parameters; and
combining a set of second luma samples using the set of second model parameters to generate the second chroma sample of the current coding block, wherein the current image frame is reconstructed based on both the first chroma sample and the second chroma sample of the current coding block;
wherein the set of first model parameters is distinct from the set of second mode parameters.

3. The method of claim 2, wherein the set of first model parameters of the first partition corresponds to a first filter shape, and the set of second model parameters of the second partition corresponds to a second filter shape distinct from the first filter shape.

4. The method of claim 2, wherein both the set of first model parameters of the first partition and the set of second model parameters of the second partition correspond to a first filter shape, and at least one of the set of first model parameters is different from a respective one of the set of second model parameters.

5. The method of claim 1, wherein the multi-partition prediction mode indicated by the first syntax element includes a geometric partitioning mode (GPM), and the first syntax element indicates that the GPM is enabled to apply non-rectangular partitioning to the current coding block and create in the plurality of partitions.

6. The method of claim 1, wherein at least two different sets of model parameters are applied to the plurality of partitions of the current coding block, independently of a plurality of syntax elements included in the video bitstream.

7. The method of claim 1, wherein the video bitstream includes a second syntax element for a partition-based cross-component prediction (CCP) mode, the second syntax element indicating that the partition-based CCP mode is enabled to apply two or more sets of model parameters to the plurality of partitions of the current coding block.

8. The method of claim 1, wherein the video bitstream includes a third syntax element for a partition-based CCP mode, the method further comprising:
determining that the third syntax element indicates that the partition-based CCP mode is disabled for a first coding block; and
apply a set of block-level model parameters to a plurality of partitions of the first coding block.

9. The method of claim 1, further comprising:
determining that the current coding block is coded in one of an inter prediction mode, an intra block copying mode, and an intra template-matching based prediction mode.

10. The method of claim 1, wherein:
the current coding block is immediately adjacent to a template area including a first template region, and the first template region is immediately adjacent to the first partition; and
the set of first model parameters is determined based on reference samples of the first template region.

11. The method of claim 10, wherein:
the template area further includes a second template region immediately adjacent to a second partition of the current coding block; and
a set of second model parameters is determined based on reference samples of the second template region, and applied to reconstruct a second chroma sample of the second partition based on a set of second luma samples.

12. A computing system, comprising:
control circuitry; and
memory storing one or more programs configured to be executed by the control circuitry, the one or more programs further comprising instructions for:
receiving video data including a current image frame, wherein the current image frame includes a current coding block;
encoding the current image frame;
transmitting the encoded current image frame via a video bitstream; and
signaling, via the video bitstream, the current image frame and a first syntax element for a multi-partition prediction mode;
wherein when the multi-partition prediction mode is enabled, the current coding block is reconstructed based on a plurality of partitions, and each of the plurality of partitions include a respective chroma sample and a set of respective luma samples, and corresponds to a set of respective model parameters applied to reconstruct the respective chroma sample based on the set of respective luma samples.

13. The computing system of claim 12, the one or more programs further comprising instructions for:
in accordance with a determination that a sample size of luma samples of the first partition is equal to or lower than a sample size threshold, determining that the video bitstream includes a fourth syntax element for a CCP mode, the fourth syntax element indicating that the CCP mode is enabled to reconstruct the first chroma sample of the first partition based on the set of first luma samples.

14. The computing system of claim 13, the one or more programs further comprising instructions for:
determining a coding block size of the current coding block; and
determining the sample size threshold based on the coding block size.

15. The computing system of claim 12, the one or more programs further comprising instructions for:
in accordance with a determination that a sample size of luma samples of at least one of the plurality of partitions is equal to or lower than a sample size threshold, determining that the video bitstream includes a second syntax element for a partition-based CCP mode, the second syntax element indicating that the partition-based CCP mode is enabled to apply two or more sets of model parameters to the plurality of partitions of the current coding block.

16. The computing system of claim 15, the one or more programs further comprising instructions for:
determining a coding block size of the current coding block; and
determining the sample size threshold based on the coding block size.

17. A non-transitory computer-readable storage medium storing one or more programs for execution by control circuitry of a computing system, the one or more programs comprising instructions for:
receiving video data including a current image frame, wherein the current image frame includes a current coding block;
encoding the current image frame; and
transmitting the encoded current image frame via a video bitstream;
wherein the video bitstream comprises the current image frame that further includes a current coding block and a first syntax element for a multi-partition prediction mode; and
wherein when the multi-partition prediction mode is enabled, the current coding block is reconstructed based on a plurality of partitions, and each of the plurality of partitions include a respective chroma sample and a set of respective luma samples, and corresponds to a set of respective model parameters applied to reconstruct the respective chroma sample based on the set of respective luma samples.

18. The non-transitory computer-readable storage medium of claim 17, wherein the current image frame further includes a second coding block distinct form the current coding block, the one or more programs further comprising instructions for:
in accordance with a determination that the multi-partition prediction mode is enabled for luma samples of the second coding block and that a dual-tree mode is enabled, disabling cross component prediction for reconstructing chroma samples of the second coding block.

19. The non-transitory computer-readable storage medium of claim 17, wherein the current image frame further includes a second coding block distinct form the current coding block, the one or more programs further comprising instructions for:
in accordance with a determination that the multi-partition prediction mode is enabled for luma samples of the second coding block, that a dual-tree mode is enabled, and that a sample size of the luma samples of the second coding block is greater than or equal to a sample size threshold, disabling cross component prediction for reconstructing chroma samples of the second coding block.

20. The non-transitory computer-readable storage medium of claim 17, wherein the current image frame further includes a second coding block distinct form the current coding block, the one or more programs further comprising instructions for:
in accordance with a determination that the multi-partition prediction mode is enabled for luma samples of the second coding block and that a single-tree mode is enabled for chroma samples of the second coding block, disabling cross component prediction for reconstructing chroma samples of the second coding block.
